(19) United States
(12) Patent Application Publication
(10) Pub. No.: US 2007/0001139 A1
(43) Pub. Date: Jan. 4, 2007

(54) Electrically actuatable valve

(76) Inventors: Walter Fleischer, Stuttgart (DE); Andrzej Pilawski, Vaihingen/Enz (DE); Norbert Keim, Loechgau (DE)

Correspondence Address: STRIKER, STRIKER & STENBY, 103 EAST NECK ROAD, HUNTINGTON, NY, 11743, US

(21) Appl. No.: 11/434,466

(22) Filed: May 15, 2006

(30) Foreign Application Priority Data
Jun. 30, 2005 (DE) 10 2005 030 959.3

(51) Int. Cl. F16K 31/02

(52) U.S. Cl. 251/129.15; 251/368

(57) ABSTRACT

For an electrically actuatable valve, in particular a pressure control valve for a transmission of a motor vehicle, with a hydraulic part and a magnet part that includes at least one solenoid coil and a movably supported solenoid armature which acts on an operating element of the valve, the solenoid armature being supported in the magnet part by at least one spring element, it is provided that the at least one spring element be made of a titanium alloy containing more than 1.5 percent by weight of titanium, and preferably more than 2 percent by weight of titanium.

### CROSS-REFERENCE TO A RELATED APPLICATION

The invention described and claimed hereinbelow is also described in German Patent Application DE 102005030959.3 filed on Jun. 30, 2005. This German Patent Application, whose subject matter is incorporated here by reference, provides the basis for a claim of priority of invention under 35 U.S.C. 119(a)-(d).

### BACKGROUND OF THE INVENTION

The present invention relates to an electrically actuatable valve.

An electrically actuatable valve for a motor vehicle transmission is made known in DE 100 48 061 Cl. A valve of this type is used in the automatic transmission of a motor vehicle to control or regulate the hydraulic pressure in pressure lines of the transmission, and it has a magnet part and a valve part. An electromagnet with a solenoid armature is located in the magnet part, the solenoid armature acting on an operating element to open and close the valve, the operating element actuating a valve-closing member that interacts with a valve seat. With the known valve, the solenoid armature bears against a fixed support point in the magnet portion by the force of a spring element, which serves as a reset spring.

An electrically actuatable valve that includes a hydraulic part made of plastic is made known in DE 100 24 700 A1. The use of a plastic hydraulic part, in particular for the valve flange with pressure connections, makes it possible to manufacture complex connection geometries using injection-moulding technology.

A plurality of identically-designed, electrically actuatable valves is generally installed in motor vehicle transmissions, the same types of valves being matched to different control loops. To ensure the dynamic stability of the electrically actuatable valves in all control loops, a very stiff spring element is used between the solenoid armature and a fixed support point in the magnet part of the valve. With the valves known in the related art, in particular valves that use a plastic flange with a high temperature expansion coefficient, a somewhat unacceptable temperature course of the pressure-current curve of the valve was observed; it represents the dependence of hydraulic pressure set by the valve on the flow of current through the solenoid coil.

It was found that, with the known electrical valves, a substantial portion of the temperature-dependent behavior of the pressure-current curve is due to a temperature-dependent reduction in the elasticity module of the material of the spring element that acts on the solenoid armature. With the known valves, the temperature-dependent change in the elasticity module of the spring element causes the spring force to drop, which results in a disadvantageous temperature course of the pressure-current curve. This applies in particular for valves that use a valve flange made of plastic with a high temperature value.

### SUMMARY OF THE INVENTION

Accordingly, it is an object of the present invention to provide an electrically actuatable valve, which is a further improvement of the existing valves.

In keeping with these objects and with others which will become apparent hereinafter, one feature of the present invention resides, briefly stated, in an electrically actuatable valve, comprising a hydraulic part; a magnet part that includes at least one solenoid coil and a movably supported solenoid armature; an operating element on which said solenoid armature acts; at least one spring element with which said solenoid is supported in said magnet part, said at least one spring element being composed of a titanium alloy containing more than 1.5 percent by weight of titanium.

The electrically actuatable valve according to the present invention uses a spring element as the reset element for the solenoid armature, the spring element being composed of a titanium alloy containing more than 1.5 percent by weight of titanium, by way of which it is advantageously ensured that the loss of force by the spring element in a temperature range of −45° C. to over 200° C. is minimal.

The use of a nickel alloy is particularly advantageous, in particular a nickel-iron-chronium alloy that is capable of being precipitation-hardened via the addition of at least 1.5 and preferably more than 2 percent by weight of titanium.

With spring elements for pressure control valves made of a titanium alloy, a thermostable course of the elasticity module in a temperature range of −45° C. to 65° C. is possible. In the temperature range above 200° C., the extent of the reduction of the elasticity module can be reduced when the temperature increases. When the temperature increases in this range, the elasticity module therefore does not drop off as extremely as with the spring elements made known in the related art. By using a spring element made of a titanium alloy with more than 1.5 percent by weight of titanium as the reset spring for a solenoid armature of an electrically actuatable valve, the temperature dependence of the pressure-current curve of the valve can therefore be advantageously influenced overall.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows an electrically actuatable valve according to the present invention with a compression spring element that acts on a solenoid armature,

FIG. 2 shows the shape of the pressure-current curve of the valve in FIG. 1 at different temperatures.

### DESCRIPTION OF THE PREFERRED EMBODIMENTS

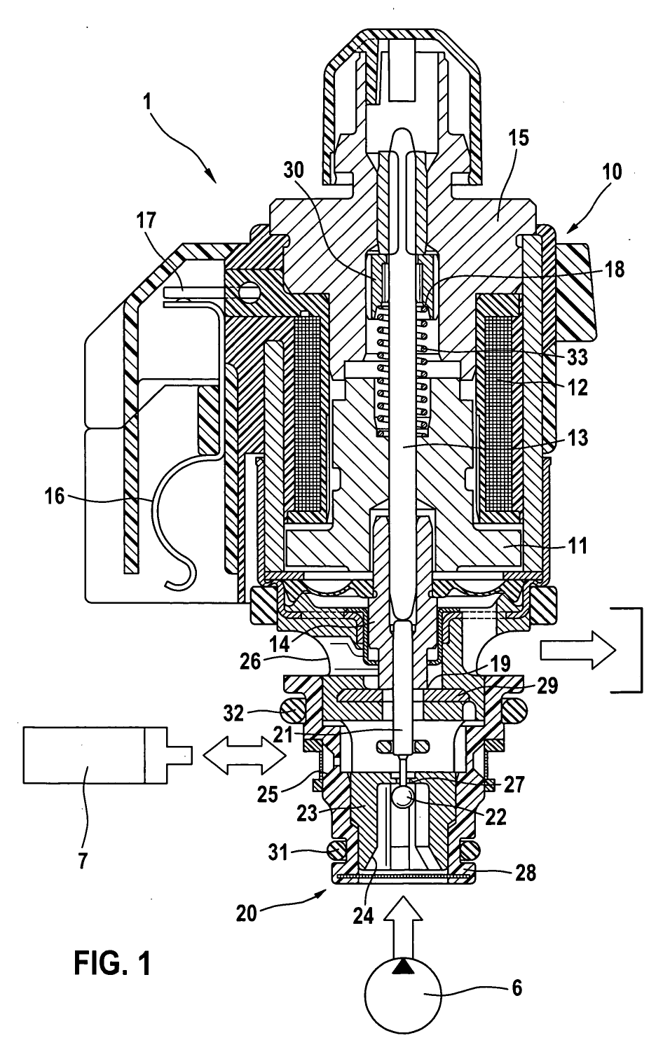

FIG. 1 shows an exemplary embodiment of an electrically actuatable valve 1. This is a pressure control valve for motor vehicle transmissions, as an example. The present invention can also be used with other electrically actuatable valves, however. Valve 1 includes a magnet part 10 and a hydraulic part 20. Magnet part 10 has an electromagnet that includes a solenoid armature 11, a magnetic core 15 and a solenoid coil 12. Electrical connections 17 of solenoid coil 12 are connected with an electrical contact element 16.

Solenoid armature 11 is fixedly connected with an anchor rod 13 that penetrates the solenoid armature 12, anchor rod 13 being provided with a sleeve 14 on its end facing hydraulic part 20, and which acts on a plunger 21—provided as an operating element—in hydraulic part 20. Plunger 21 acts on a valve-closing member 22, which is preferably designed as a ball. Hydraulic part 20 further includes a flange 23, which is designed as a plastic injection-moulded part in this exemplary embodiment. Flange 23 is provided with a pressure connection 24 for connection to a pressure source 6, a working connection 25 for connection to an electrical line 7, and a return connection 26.

The front side of sleeve 14, in combination with a metallic locking disk 29 injected in flange 23, forms a first poppet valve 19. The return of hydraulic fluid from working connection 25 to return connection 26 is controlled via the distance of sleeve 14 away from locking disk 29. Valve-closing member 22 forms, in combination with a second valve seat formed on flange 23, a second poppet valve 27, which controls the supply of hydraulic fluid from pressure connection 24 to working connection 25. A filter cage 28 is inserted onto flange 23, filter cage 28 being provided with sealing rings 31, 32 on its outer circumference.

The opening and closing motion of valve-closing member 22 on the second valve seat, and the distance between sleeve 14 and the first valve seat is influenced by the motion of solenoid armature 11. Reference is made to DE 100 24 700 A1 and the parallel publication US 6 719 006 with regard for the hydraulic functionality of the pressure control valve.

Anchor rod 13 is slidably-displacably supported in a guide 20 bush 30 with its end facing magnetic core 15, so that, when current is applied to solenoid coil 12, solenoid armature 11 moves against the force of a spring element 33 toward the magnetic core, and first poppet valve 19 opens. In this case, plunger 21 also moves toward magnetic core 15, and second poppet valve 27 is closed by valve-closing member 22. When magnetic core 12 is turned off, solenoid armature 11 is moved by the pressure force of spring element 33—which is preferably designed as a compression-spring element—away from magnetic core 15, by way of which first poppet valve 19 is closed and second poppet valve 27 is opened.

Spring element 33 encloses anchor rod 13 and bears, with one end and in magnet part 15, against a fixed support point 18, which can be formed on guide bush 30, for example. Spring element 33 bears with the other end against solenoid armature 11. An important part of the present invention is that spring element 33, which acts on solenoid armature 11, is made of a metal alloy that contains at least 1.5 percent by weight of titanium. The alloy preferably contains more than 2% titanium, but less than 20% titanium. In a preferred exemplary embodiment, the spring element is composed of a nickel alloy, to which more than 2% titanium has been added. In a further advantageous embodiment, the spring element is composed of a nickel-iron-chromium alloy, which is capable of being precipitation-hardened due to the addition by alloying of at least 2 percent by weight of titanium and aluminium.

Precipitation-hardening is a diffusion-controlled process that is well-established in the related art, the process being deliberately influenced via thermal treatment, by way of which the mechanical properties can be greatly influenced. A hardened metal alloy containing titanium which is suited for use in manufacturing the spring element for electrically actuatable valves is, e.g., NI-SPAN-C ® alloy 902, which is available from Special Metals Corporation, Huntington, West Virginia, USA.

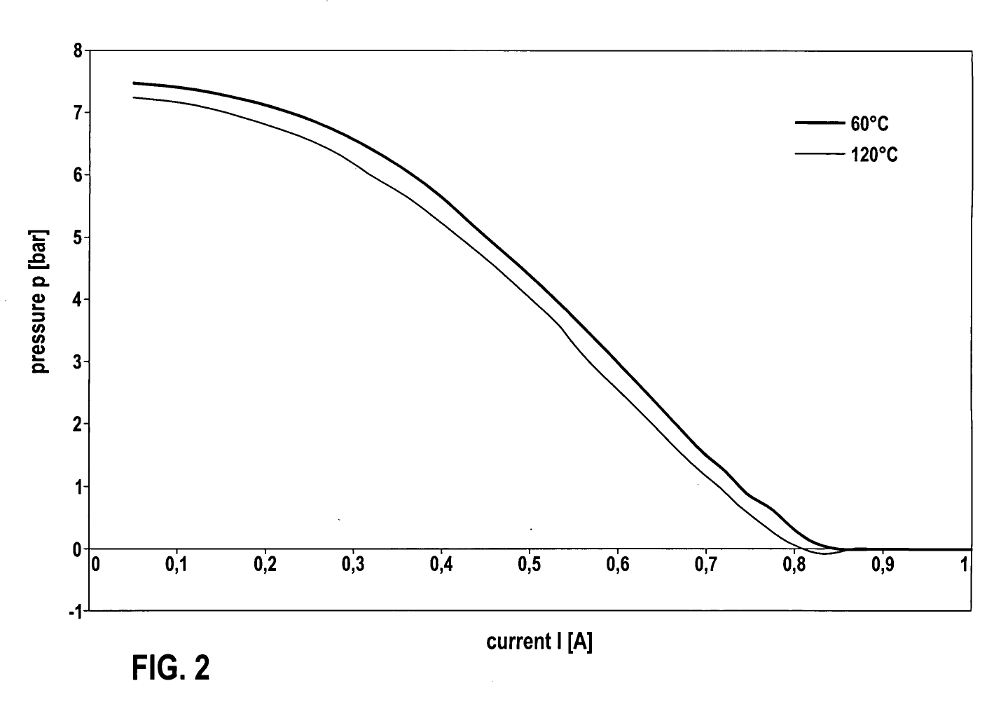

FIG. 2 shows the pressure-current curve of an electrically actuatable valve according to the present invention for the two temperatures 60° C. and 120° C., as an example. It is clear that the 120° C. curve is not much lower than the 60° C. curve. This difference is much more pronounced in the related art.

It will be understood that each of the elements described above, or two or more together, may also find a useful application in other types of constructions differing from the types described above.

While the invention has been illustrated and described as embodied in an electrically actuatable valve, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. An electrically actuatable valve, comprising a hydraulic part; a magnet part that includes at least one solenoid coil and a movably supported solenoid armature; an operating element on which said solenoid armature acts; at least one spring element with which said solenoid is supported in said magnet part, said at least one spring element being composed of a titanium alloy containing more than 1.5 percent by weight of titanium.

2. An electrically actuatable valve as defined in claim 1, wherein said at least one spring element is composed of the titanium alloy containing more than 2 percent by weight of titanium.

3. An electrically actuatable valve as defined in claim 1, wherein said spring element is composed of a material selected from the group consisting of nickel and nickel alloy, to which titanium has been added.

4. An electrically actuatable valve as defined in claim 1, wherein said spring element is composed of a nickel-iron-chromium alloy, to which titanium has been added.

5. An electrically actuatable valve as defined in claim 1, wherein said spring element is composed of a nickel-iron-chromium alloy, to which titanium and aluminium have been added.

6. An electrically actuatable valve as defined in claim 1, wherein said spring element is formed as precipitation-hardened spring element.

7. An electrically actuatable valve as defined in claim 1, wherein a titanium portion of the alloy is greater than 1.5 percent by weight.

8. An electrically actuatable valve as defined in claim 7, wherein the titanium portion of the alloy is greater than 2 percent by weight and less than 20 percent by weight.

9. An electrically actuatable valve as defined in claim 1; and further comprising a flange which is composed of plastic.

10. An electrically actuatable valve as defined in claim 1, wherein said spring element is configured as a spring selected from the group consisting of a helical spring and a spiral spring.

11. A spring element for use in a magnet part of an electrically actuatable valve defined in claim 1, wherein the spring element is composed of a titanium alloy with a titanium portion of more than 1.5 percent by weight.

12. A spring element as defined in claim 11, wherein the titanium portion of the titanium alloy is more than 2 percent by weight.

13. A spring element as defined in claim 10, wherein the spring element is composed of a material selected from the group consisting of nickel and nickel alloy, to which titanium has been added.

14. A spring element as defined in claim 11, wherein the spring element is composed of a precipitation-hardened nickel-iron-chromium alloy that contains more than 1.5 and less than 20 percent by weight of titanium.
